(19) United States
(12) Patent Application Publication
(10) Pub. No.: US 2022/0403808 A1
(43) Pub. Date: Dec. 22, 2022

(54) System of power generation from rainfall on buildings and structures

(71) Applicant: Matt Mullins, Chicago, IL (US)

(72) Inventor: Matt Mullins, Chicago, IL (US)

(21) Appl. No.: 17/349,753

(22) Filed: Jun. 16, 2021

(51) Int. Cl. F03B 13/00; E04D 13/08

(52) U.S. Cl. CPC F03B 13/00; E04D 13/08

(57) ABSTRACT

The invention indicates ways to assemble turbines, pipes, and check valves as a set or series of sets to produce electricity from rainwater off of high rises, buildings, parking garages, and other structures.

### CROSS-REFERENCE TO RELATED APPLICATIONS

Hydro electric charging assembly, U.S. Pat. No. 10,819,186 B2

Reclaiming energy from waste water in tall buildings U.S. Pat. No. 8,610,295

Method and apparatus for supplying fresh water and generating electricity by collected rainwater U.S. Pat. No. 7,348,685

### BACKGROUND OF THE INVENTION

Hydroelectric energy has existed for some time and has mainly been applied to the damming of rivers. More recent alternative applications have been tied to the harvesting of tidal flows, as well as waste water in high rises. No invention has aimed to generate electricity via a pressurized water column on the side of a building, taking advantage of rainfall being corralled off of the roof.

The idea of the invention is to harness the potential energy of rainfall on the roof of buildings and tops of structures. This is done through a pressurized water column on the side of buildings that is activated with the addition of rainfall into the system. The majority of water from the roof is corralled to a specific area where it will flow into a single set or series of energy producing devices. The water at the bottom of the sealed pipe will be pressurized from the weight of the water above it, thus allowing it to move an optimized turbine. The object of this invention is to act as an alternative form of energy generation. One advantage of the system is that rain is a renewable form of energy. Another advantage of this system is that it offers hydroelectric power without the need of a river dam, which can be harmful towards endangered species. The main disadvantage of this invention is that there is no power generation when it is not raining. No water is permanently stored on the top of the roof, only in the water column or downspout pipe. Another disadvantage is the system can not capture 100% of the potential energy of rainfall.

### BRIEF DESCRIPTION OF THE SEVERAL VIEWS OF THE DRAWING

FIG. 1a-1d: Drawings indicating a single assembled set of the energy producing apparatus

FIG. 2a-2d : Drawings showing a series of assembled energy producing sets

FIG. 3a-3b : Drawing showing a series of assembled energy producing sets on a building

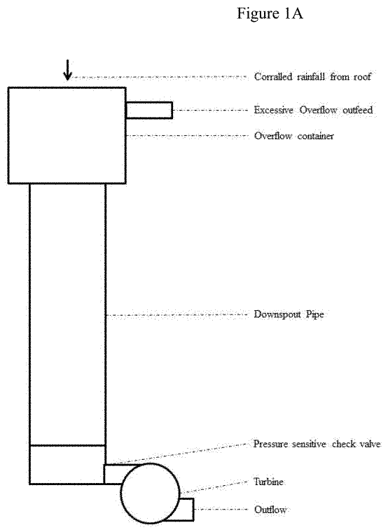

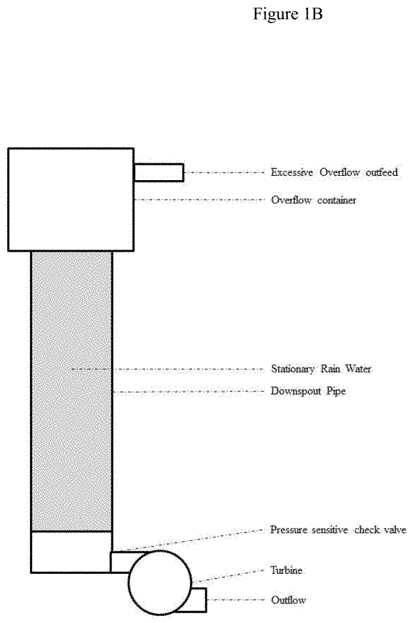

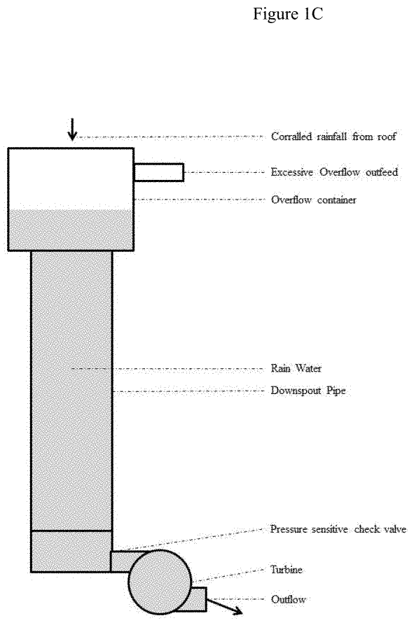

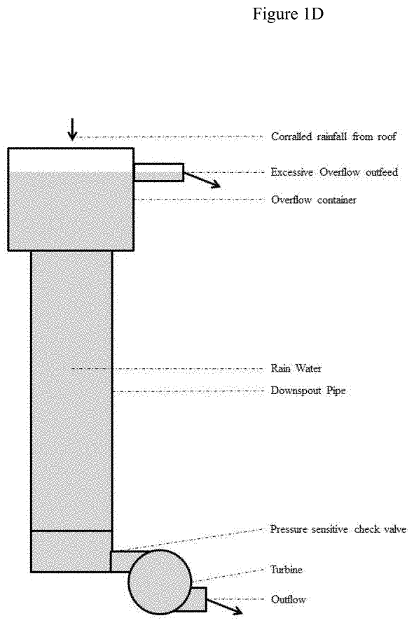

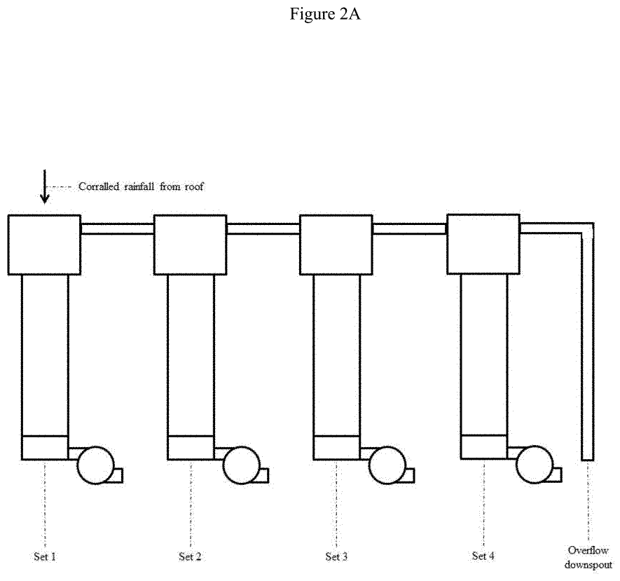

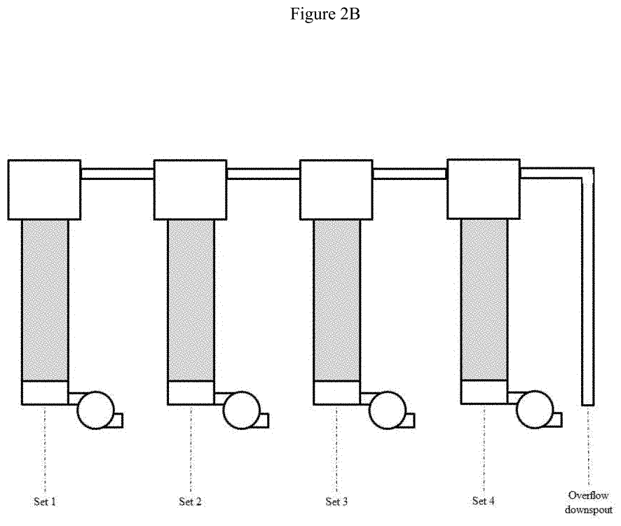

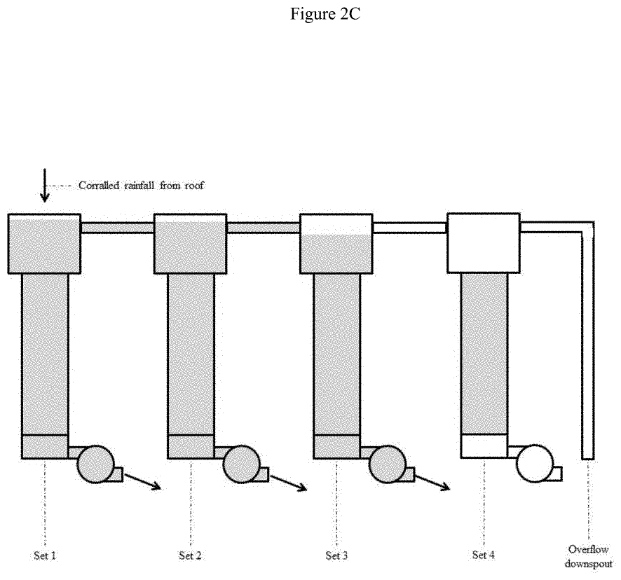

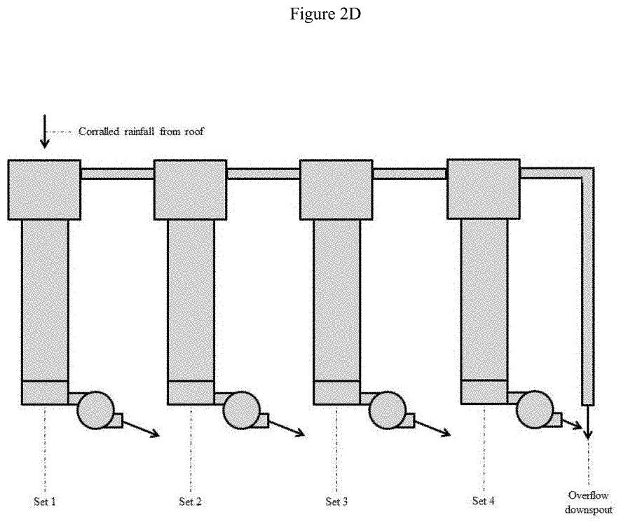

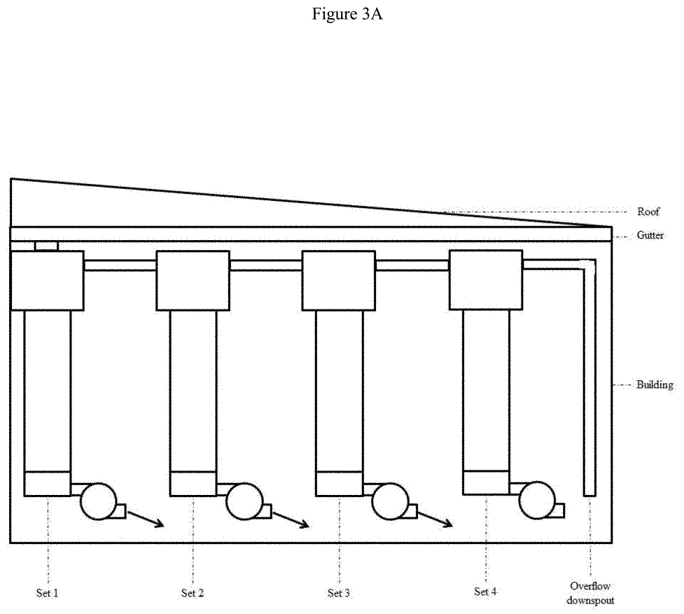

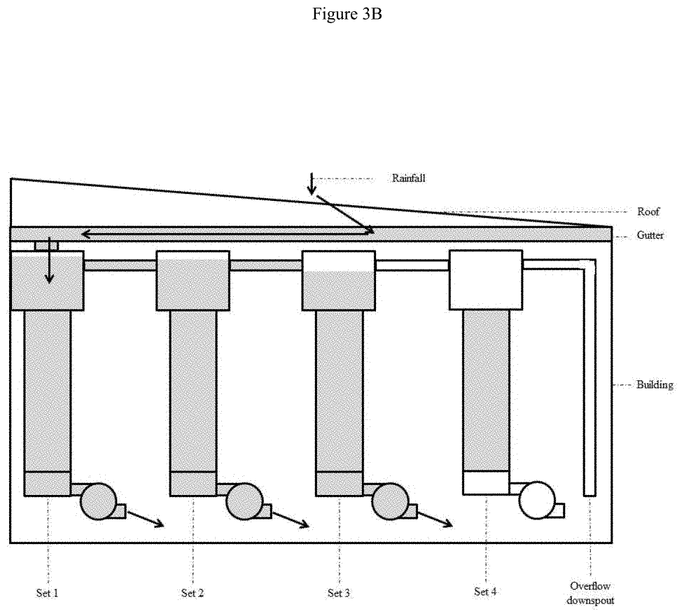

### DETAILED DESCRIPTION OF THE INVENTION

The invention is a combination of a series of sealed downspouts and turbines optimized to convert the potential energy of rainfall on top of a building to power. The sealed downspouts each go to a specific turbine. The combination of the sealed downspout and turbine are optimized for a specific flow rate of water or amount of rainfall. When one sealed downspout has reached its maximum flow rate, it will overflow into the next downspout in the series. This repeats down the series until there is no more rainfall overflow. Due to the variable nature in rainfall, its possible to have 1 of the turbines in the series running or multiple.

The sealed downspouts are each filled with water even while the turbines are not running. A check valve is located at the bottom of each sealed downspout such that water is only allowed to pass once the water column reaches a specific height or water pressure. Water is corralled by taking advantage of the roof architecture or via the construction of additional slopes. The trigger of the check valve is rainfall which will raise the height of the water column in the sealed downspout as water is corralled into the sealed downspout. Once the check valve is opened, rain water will be pushed out via the high pressure of the water column through a small hole at the bottom of the sealed pipe in a jet like fashion to power a turbine.

Turbines have commonly been in use in rivers and lakes, but have not been adapted for use with buildings or many different city structures. Utilizing small turbines with a series of check valves and sealed downspouts has the potential to generate high amounts of hydroelectric power during rain. Several models have been developed to highlight the amount of electricity generated. A moderate rainfall (0.1 inch/hour) has the potential to generate large amounts of power on a high rise, apartment building, or parking garage. The USF Beard parking garage would generate an estimated 3000 Kw/h in a moderate rainfall utilizing an optimized series of downspouts, check valves, and turbines. The Rivergate tower in Tampa would generate an estimated 4000 Kw/h in a moderate rainfall utilizing an optimized series of downspouts, check valves, and turbines.

What is claimed:

1. A system for generating electricity via a pressurized downspout pipe in which a water column is stored on the side of the building and activated via rainfall which activates a pressure sensitive check valve to a turbine.

2. A series of assembled pressurized downspout pipes, check valves, turbines, and overflow containers optimized to generate electricity at varying rates of rainfall.
